(19) United States
(12) Patent Application Publication
(10) Pub. No.: US 2008/0010987 A1
(43) Pub. Date: Jan. 17, 2008

(54) Method of operating an internal combustion engine in the engine braking mode

(76) Inventors: Michael Benz, Ostfildern (DE); Stephen Kratschmer, Schwabisch Gmund (DE); Thomas Rohrer, Durmersheim (DE)

Correspondence Address: KLAUS J. BACH, 4407 TWIN OAKS DRIVE, MURRYSVILLE, PA, 15668, US

(21) Appl. No.: 11/796,797

(22) Filed: Apr. 27, 2007

Related U.S. Application Data
(63) Continuation-in-part of application No. PCT/EP05/11120, filed on Oct. 15, 2005.

(30) Foreign Application Priority Data
Oct. 29, 2004 (DE) 10 2004 052 670.2

(51) Int. Cl. F02D 13/04; F01L 13/06; F02B 37/22

(52) U.S. Cl. 60/600

(57) ABSTRACT

In a method of operating an internal combustion engine in the engine braking mode, wherein an adjustable cross section adjusting means is provided in the exhaust system upstream of the exhaust gas purification device and at least one of the cylinders of the internal combustion engine is provided with a throttle valve, which, in the engine braking mode, is opened so that the cylinder content is discharged directly into the exhaust system during the compression stroke of the piston and at the same time, the cross section adjusting means is moved into a blocking position, whereupon an increased pressure level is generated in the exhaust system, in the event that a characteristic variable which corresponds to the exhaust gas temperature exceeds a given limit value, the cross section adjusting means is briefly opened and subsequently again closed to avoid overheating of the exhaust system.

This is a Continuation-In-Part Application of pending International Patent Application PCT/EP2005/011120 filed Oct. 15, 2005 and claiming the priority of German Patent Application 10 2004 052 670.2 filed Oct. 29, 2004.

### BACKGROUND OF THE INVENTION

The invention relates to a method of operating an internal combustion engine in the engine braking mode wherein the engine includes an exhaust system with an exhaust gas purification device and a control means for controlling the flow cross-section of the exhaust gas through the exhaust system.

DE 195 43 190 C2 describes an engine braking method for a charged internal combustion engine which is equipped with an exhaust gas turbocharger whose exhaust gas turbine, which is arranged in the exhaust system, is provided with a variable turbine geometry for variably adjusting the effective turbine inlet flow cross section. In the engine braking mode, the variable turbine geometry assumes a blocking position which reduces the flow cross section, as a result of which the exhaust gas back pressure in the line section between the cylinder outlet and the exhaust gas turbine is increased. The exhaust gas flows at high speed through the remaining flow ducts between the guide blades of the variable turbine geometry and impinges on the turbine wheel, whereupon the compressor in the intake tract is also driven and an overpressure is built up. At the inlet side, the cylinders of the internal combustion engine are thereby subjected to an increased charge pressure, and at the outlet side, an overpressure prevails between the cylinder outlets and the exhaust gas turbine, which overpressure counteracts the discharge of the air, which therefore is compressed in the cylinders, and is conducted via throttle valves into the exhaust system. In the engine braking mode, the pistons of the internal combustion engine must therefore, in the compression stroke, exert compression work counter to the high overpressure in the exhaust system, making it possible to generate high levels of braking power.

A catalytic converter for purifying the exhaust gases before they are discharged to the atmosphere is conventionally arranged in the exhaust system downstream of the exhaust gas turbine. In the engine braking mode, however, because of the high exhaust gas back pressure, the temperature in the exhaust system may increase to such an extent that there is the risk of damage to the catalytic converter.

In order to avoid such damage, in an internal combustion engine described in JP 2002188491, fuel is injected intermittently, resulting in an oxidation-promoting atmosphere being generated in the exhaust system, which helps to avoid overheating of the catalytic converter. The fuel injection, however, has an effect on the braking power, which leads to an undesired braking power variation. Depending on the injection time, this can lead to an increase or decrease in braking power.

It is the principal object of the invention to avoid overheating of an exhaust gas purification device in the exhaust system during operation of the engine in the engine braking mode using simple measures by which, the engine braking power is expediently is kept at least approximately constant that is below a destructive level.

### SUMMARY OF THE INVENTION

In a method of operating an internal combustion engine in the engine braking mode, wherein an adjustable cross section adjusting means is provided in the exhaust system upstream of the exhaust gas purification device and at least one of the cylinders of the internal combustion engine is provided with a throttle valve, which, in the engine braking mode, is opened so that the cylinder content is discharged directly into the exhaust system during the compression stroke of the piston and at the same time, the cross section adjusting means is moved into a blocking position, whereupon an increased pressure level is generated in the exhaust system, in the event that a characteristic variable which corresponds to the exhaust gas temperature exceeds a given limit value, the cross section adjusting means is briefly opened and subsequently again closed to avoid overheating of the exhaust system.

The brief opening of the cross section adjusting member causes a dissipation of the high exhaust gas back pressure, as a result of which the temperature in the exhaust system is also reduced. The temperature in the exhaust gas purification device can thereupon fall again below a non-critical limit value. A brief opening of the cross section adjusting member is to be understood to mean that, during the engine braking mode, the cross section adjusting member is basically in the blocking position and is only opened until a characteristic variable exceeds or falls below a predefined value, for example until a predefined time span has expired or the vehicle speed has increased by a certain value or a temperature characteristic variable has exceeded a certain threshold value.

Since the cross section adjusting member is opened only for a short period, there is little effect on the engine braking power. Only a slight fluctuation of the engine braking power is to be expected, in particular a brief drop in the engine braking power. The degree of fluctuation is only slight since the period over, which the cross section adjusting means is opened, is only brief so that the pressure drop is also kept within limits. The pressure is built up again quickly because of the increased movement of the air mass in the engine or exhaust gas tract when the cross section adjusting member is opened. As a result of the immediate closure of the cross section adjusting member, the air mass flow is again slowed down, and the kinetic energy contained in the gas is converted into pressure energy.

The catalytic converter inlet temperature in particular is incorporated as a characteristic variable which correlates with the exhaust gas temperature and is taken into consideration in the decision as to whether the cross section adjusting member should be briefly opened. In addition, characteristic variables which correlate with the exhaust gas temperature can also be other state or operating variables in the internal combustion engine or in one of the units assigned to the internal combustion engine, in particular the exhaust gas temperature in the line section between the cylinder outlet and the cross section adjusting member, or else other temperature variables. If appropriate, non-temperature variables can also be used, for example the exhaust gas back pressure.

The time duration for which the cross section adjusting member is in the open position can be made dependent on various influential variables. On the one hand, a minimum time span can be predefined for which the cross section adjusting member remains open, and after the expiry of which the cross section adjusting member is adjusted back to the blocking position. On the other hand, it is also possible to introduce additional conditions which are to be incorporated, which conditions must be met in each case individually or cumulatively after the expiry of the minimum time-span in order that the cross section adjusting member can be adjusted back to the blocking position. These conditions include, for example, the expiry of a maximum time span, the increase of the vehicle speed by a predefined value, or the fall of the catalytic converter inlet temperature below a threshold value.

During the brief opening of the cross section adjusting member, the throttle valve expediently remains in its open position, so that engine braking power is also produced during the opening period of the cross section adjusting member.

The cross section adjusting member can on the one hand be an engine braking flap which is arranged in the exhaust system upstream of the exhaust gas purification device. On the other hand, however, a variable turbine geometry in an exhaust gas turbine which is part of an exhaust gas turbocharger can also be used as a cross section adjusting member, with the variable turbine geometry serving to adjust the effective turbine inlet cross section in the exhaust gas turbine. In the blocking position of the variable turbine geometry, the exhaust gas back pressure is increased as a result of the reduced flow cross section, and said exhaust gas back pressure is dissipated again in the open position. It is possible even in the blocking position of the variable turbine geometry for the gas in the exhaust system to impinge on the turbine wheel via the remaining free flow cross section, whereby said turbine wheel is subjected to a driving impetus and the compressor wheel is also driven. In this way, a high pressure level is provided overall both in the intake tract and in the exhaust system, thereby increasing the braking power level. In order to increase the engine braking power, for example in the event of an emergency braking maneuver, the variable turbine geometry can be moved into the blocking position, the throttle valve can be opened to a maximum degree and, at the same time, before top dead center, a maximum possible fuel quantity can be injected into, and burned in, the combustion chambers whereupon a pressure is generated in the combustion chamber counteraction the upward-moving piston.

If appropriate, use can also be made of a combination of variable turbine geometry and an engine braking flap downstream of the exhaust gas turbine, thereby providing additional adjustment capacity.

In one advantageous embodiment, the brief opening of the cross section adjusting member is indicated to the driver, in order to inform him that measures for reducing the catalytic converter temperature have been taken.

Further advantageous and expedient embodiments of the invention will become more readily apparent from the following description thereof with reference to the accompanying drawings:

### BRIEF DESCRIPTION OF THE DRAWINGS

FIG. 1 is a schematic illustration of an internal combustion engine having an exhaust gas turbocharger and an engine braking flap downstream of the exhaust gas turbine and upstream of a catalytic converter, and

FIG. 2 is a flow diagram with individual method steps for operating the internal combustion engine in the engine braking mode.

### DESCRIPTION OF PARTICULAR EMBODIMENTS

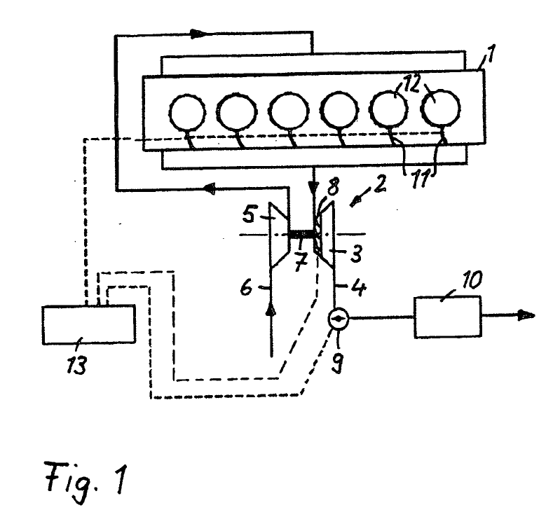

The internal combustion engine 1 illustrated in FIG. 1 is a diesel engine which is used in particular in heavy utility vehicles. Use in a spark-ignition engine however also falls within the scope of the invention.

The internal combustion engine 1 includes an exhaust gas turbocharger 2 which comprises an exhaust gas turbine 3 in the exhaust system 4 and a compressor 5 in the intake tract 6, with the turbine wheel being rotationally fixedly connected to the compressor wheel by means of a shaft 7. The exhaust gas turbine 3 is equipped with a variable turbine geometry 8 for variably adjusting the effective turbine inlet cross section. The variable turbine geometry is for example a guide vane structure which is arranged in the turbine inlet flow passage and has adjustable guide vanes, or a guide vane structure with fixed guide vanes, which can be moved axially into the turbine inlet cross section. The variable turbine geometry 8 can be adjusted between a blocking position, which minimizes but does not completely close the flow passage, and an open position which opens up the flow passage to a maximum degree.

It may also be expedient to use an exhaust gas turbine with fixed geometry in which there is no possibility for adjusting the effective turbine inlet flow cross section, and to regulate the flow cross section only by means of the engine braking flap.

Arranged downstream of the exhaust gas turbine 3 in the exhaust system 4 is an engine braking flap 9 which is likewise to be adjusted between a blocking position, which minimizes the flow cross section in the exhaust system, and an open position which opens up the flow cross section to a maximum degree. Additionally arranged in the exhaust system 4, downstream of the engine braking flap 9, is an exhaust gas purification device 10, in particular a catalytic converter.

Each cylinder 12 of the internal combustion engine 1 is assigned in each case one throttle valve 11 which, in the engine braking mode, is moved into an open position, whereupon the cylinder content can escape directly via the open throttle valve into the exhaust system 4. The lift and the opening duration of the throttle valves 11 are expediently adjustable.

In addition, the internal combustion engine 1 is assigned a control unit 13, by means of which the adjustable units of the internal combustion engine, in particular the variable turbine geometry 8, the engine braking flap 9 and the throttle valves 11 are to be adjusted as a function of state and operating variables of the internal combustion engine.

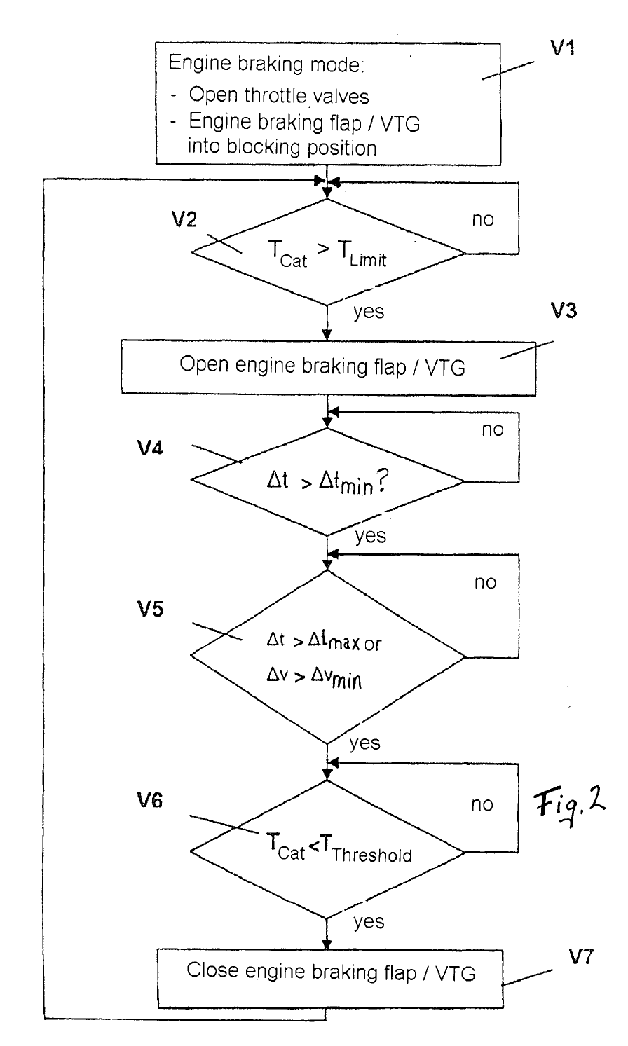

FIG. 2 illustrates a flow diagram with the individual method steps for controlling the catalytic converter temperature in the engine braking mode. In order to trigger the engine braking mode, as per method step V1, the throttle valves are opened and the engine braking flap is moved into the blocking position. At the same time, the variable turbine geometry (VTG) is moved into the blocking position. As a result, a high pressure is generated in the line section between the outlets of the cylinder of the internal combustion engine and the inlet in the exhaust gas turbine, and the gas in the line section impinges at high speed on the turbine wheel through the remaining free flow cross sections in the variable turbine geometry. The rotation of the turbine wheel is transmitted via the shaft to the compressor wheel which thereupon sucks in combustion air and compresses it to an increased charge pressure. In this way, an increased pressure level is generated both in the intake tract and in the exhaust system.

An additional adjustment capacity is obtained by means of the engine braking flap, whereby it is possible for example to realize an engine braking mode in which the variable turbine geometry is open or is in an intermediate position between the open and blocking position, and the engine braking flap is simultaneously closed. In this operating mode, on account of the relatively small pressure drop across the exhaust gas turbine, less turbine power and therefore also a lower pressure level at the intake side and at the exhaust gas side are generated.

On the other hand, an engine braking mode is also conceivable in which the engine braking flap is open and the variable turbine geometry is moved into the blocking position. On account of the high pressure drop across the exhaust gas turbine, high charger power is also generated, with a corresponding rise in the pressure level both at the intake side and at the exhaust gas side.

In order to ensure that the catalytic converter temperature T_{Cat} does not reach any damaging temperature ranges, it is checked in method step V2 as to whether the catalytic converter temperature T_{Cat} has already reached a limit value T_{Limit}, which expediently lies below a temperature which damages the catalytic converter. If the catalytic converter temperature has not yet reached said limit value T_{Limit}, then a return is made, corresponding to the “no” branch of method step V2, to the start of the query, and the query is repeated at cyclic intervals. In the event that the catalytic converter temperature T_{Cat} has exceeded the defined limit value T_{Limit}, then the following method step V3 is proceeded to, corresponding to the “yes” branch.

In method step V3, the engine braking flap and/or the variable turbine geometry are opened, whereby the exhaust gas back pressure is dissipated and therefore the temperature in the exhaust system is also reduced.

The open position of the engine braking flap/variable turbine geometry is maintained for a minimum period Δtₘᵢₙ. If the query in method step V4 yields that said period Δtₘᵢₙ has not yet elapsed, then the query is repeated at cyclic intervals, corresponding to the “no” branch. If the query in V4 yields that the period Δt over which the engine braking flap or the variable turbine geometry is held open has already reached the minimum period Δtₘᵢₙ, then the next query block V5 is proceeded to, corresponding to the “yes” branch.

In V5, it is cyclically queried as to whether the time duration Δt over which the cross section adjusting member remains open has exceeded a maximum time span Δtₘₐₓ. If this is the case, then the method proceeds corresponding to the “yes” branch. It is also queried in V5 as to whether the increase in the vehicle speed Δv is greater than a predefined value Δvₘᵢₙ. If this is the case, then the method likewise proceeds corresponding to the “yes” branch. This results in the situation where a move is made to the next method step V6 if only one of the queried conditions from method step V5 are met, which accordingly need to be met only alternatively. If, in contrast, neither condition is met, the query is repeated at cyclic intervals, corresponding to the “no” branch.

In method block V6, a further query is carried out. In V6, it is checked as to whether the catalytic converter inlet temperature T_{Cat} falls below a defined threshold value T_{Threshold}. Although said threshold value can correspond to the temperature limit value T_{Limit}, it can also deviate from said value if appropriate, and can in particular be lower than the limit value T_{Limit}, whose exceedance causes the cross section adjusting member to be moved into the open position. If the query in method block V6 is met, that is to say the catalytic converter inlet temperature T_{Cat} has fallen below the defined threshold value, then the method proceeds, corresponding to the “yes” branch, to the next method step V7; otherwise the query in V6 is repeated at cyclic intervals.

The regulation of the catalytic converter temperature is then ended, and a return can be made, as per V7, to the normal engine braking mode in which the engine braking flap and/or the variable turbine geometry VTG assume a closed position corresponding to the present load demands. A return is then made to method step V2 in order to check, at cyclic intervals, for a renewed increase of the catalytic converter temperature.

The end of the engine braking mode occurs at the demand of the driver by means of a corresponding driver actuation.

What is claimed is:

1. A method of operating an internal combustion engine of a motor vehicle in an engine braking mode, said engine having an exhaust system (4) with an exhaust gas purification device (10) and means (8, 9) for adjusting the flow cross section of in the exhaust system (4) arranged upstream of the exhaust gas purification device (10) for controlling the exhaust gas flow through the exhaust system (4) and at least one throttle valve (11) disposed associated with a cylinder (12) of the internal combustion engine (1), said method comprising the steps of opening, in the engine braking mode, the throttle valve (11) and moving the cross section adjusting means (8, 9) into a blocking position which reduces the flow cross section, and, in the event that a characteristic variable (T_{Cat}) which corresponds to the exhaust gas temperature exceeds a limit value (T_{Limit}), briefly opening the cross section adjusting means (8, 9) and moving it back again into the blocking position.

2. The method as claimed in claim 1, wherein a catalytic converter inlet temperature (T_{Cat}) is incorporated as a characteristic variable.

3. The method as claimed in claim 1, wherein the cross section adjusting means (8, 9) is adjusted back into the blocking position after the characteristic variable (T_{Cat}) falls below a threshold value (T_{Threshold}).

4. The method as claimed in claim 1, wherein the cross section adjusting means (8, 9) remains opened for a minimum time span (Δtₘᵢₙ).

5. The method as claimed in claim 4, wherein the cross section adjusting means (8, 9) is adjusted back into the blocking position after a predefined time span (Δtₘₐₓ) has expired.

6. The method as claimed in claim 1, wherein the cross section adjusting member (8, 9) remains open until the vehicle speed of the motor vehicle has increased by a predefined value (Δvₘᵢₙ).

7. The method as claimed in claim 1, wherein the throttle valve (11) remains opened during the brief opening of the cross section adjusting means (8, 9).

8. The method as claimed in claim 1, wherein the flow cross section adjusting means is an engine braking flap (9).

9. The method as claimed in claim 1, wherein the engine includes an exhaust gas turbocharger (2) having an exhaust gas turbine (3) provided in the exhaust system (4), and a compressor (5) provided in the intake tract (6).

10. The method as claimed in claim 9, wherein the cross section adjusting member is a variable turbine geometry (8) arranged in an inlet passage of the exhaust gas turbine (3) for variably adjusting the effective turbine inlet flow cross section in the exhaust gas turbine (3), wherein, in the engine braking mode, the variable turbine geometry (8) is moved into a blocking position which reduces the flow cross section.

11. The method as claimed in claim 1, wherein the brief opening of the cross section adjusting means is indicated to the driver.
